(19) United States
(12) Patent Application Publication
(10) Pub. No.: US 2016/0194430 A1
(43) Pub. Date: Jul. 7, 2016

(54) BIO-BASED POLYCARBOXYLATE ETHER AND METHODS FOR THE PRODUCTION THEREOF

(71) Applicant: SIKA TECHNOLOGY AG, Baar (CH)

(72) Inventor: Jorg Zimmermann, Winterthur (CH)

(73) Assignee: SIKA TECHNOLOGY AG, Baar (CH)

(21) Appl. No.: 14/912,003

(22) PCT Filed: Sep. 1, 2014
(86) PCT No.: PCT/EP2014/068474

§ 371 Date: Feb. 12, 2016

(30) Foreign Application Priority Data
Sep. 6, 2013 (EP) 13183378.2

(51) Int. Cl. C08F 290/06; C04B 24/32; C04B 24/26

(52) U.S. Cl. CPC C08F 290/062; C04B 24/2647; C04B 24/32; C04B 2103/30

(57) ABSTRACT

Methods for the production of polycarboxylate ethers, in which at least one bio-based starting material is used. The bio-based starting materials are, for example, selected from the group made up of polyalkylene oxide, terminally modified polyalkylene oxide, acrylic acid or a salt thereof, methacrylic acid or a salt thereof and/or maleic acid or a salt thereof. A polycarboxylate ether is at least partially bio-based. The polycarboxylate ether can be obtained in particular by the method.

### TECHNICAL FIELD

The invention relates to processes for preparing polycarboxylate ethers, in which at least one bio-based starting material is used, and to polycarboxylate ethers that are at least partly biobased.

### STATE OF THE ART

In technical fields which entail a high consumption of materials and products, there is a great and increasing demand for biobased materials and products. Biobased materials and products are at least partly produced from biological materials, especially from renewable raw materials. They have an advantageous CO₂ balance, since they are based only partly on fossil raw materials, if at all. Moreover, they can be produced in a sustainable and increasingly also inexpensive manner if the underlying biological material is of good availability, especially when by-products or waste materials from agriculture and silviculture are used.

Specifically in the construction sector, it is desirable to utilize and to use biobased materials and products, to improve the CO₂ balance and overall to enable more sustainable construction. There is therefore a general need to replace conventional materials and products based on fossil raw materials with biobased materials and products.

In the construction sector, large amounts of cements, gypsum, lime and other hydraulically setting compositions are consumed. An important additive in such compositions is organic polycarboxylate ethers. These are comb polymers having a main chain having carboxyl groups, and side chains having polyether groups, especially based on polyethylene oxide and/or polypropylene oxide. They serve particularly as processing aids, namely as dispersants and superplasticizers.

Polycarboxylate ethers are prepared in the prior art by polymerization reactions or polymer-analogous reactions, using conventional mineral oil-based raw materials as starting materials. In contrast, biobased polycarboxylate ethers based at least partly on biological materials and especially renewable raw materials are unknown to date.

EP 2 255 680 A1 describes polymers of maleic acid, allyl ethers and (meth)acrylic acid, which are especially polycarboxylate ethers, and the preparation and uses thereof. EP 1 348 729 A1 describes typical polycarboxylate ethers having polyether side chains and the use thereof in the construction sector, especially as dispersants and superplasticizers in cements. WO2005/090416 A1 describes polycarboxylate ethers having, inter alia, side chains bonded via amide groups, and the uses thereof in the construction sector in hydraulically setting compositions. EP 2 161 247 A1 describes uses of polycarboxylate ethers in cement compositions, wherein the polymers are used as mixtures with antioxidants and other additives. These publications, and also further publications in the technical field, do not contain any pointer to produce such standard mineral oil-based polycarboxylate ethers from other raw materials. More particularly, there is no specific pointer to use biobased starting materials for production.

Conventional non-biobased products that are based on petrochemistry and other fossil raw materials often cannot be replaced directly by analogous products made from renewable raw materials. This is firstly because the requisite materials made from renewable raw materials are often unavailable or at least not available in a cost- and energy-efficient manner. Secondly, products made from renewable raw materials often cannot be produced with continuous quality, since the underlying plants or microorganisms can have variable compositions and ingredients according to the external conditions, such as weather effects, fertilization, feeding, etc. Therefore, it is often impossible to assure sufficient continuous quality of the products which is required for many technical applications. Specifically in the field of construction chemistry, for example in the production of cements, variations in quality in the raw materials used are often unacceptable and potentially hazardous.

### OBJECT OF THE INVENTION

The object underlying the invention is that of providing novel processes and products which overcome the abovementioned disadvantages. It is an object of the present invention to provide novel biobased products and processes for production thereof. The products are to be usable in the construction sector in particular and are to enable significant CO₂ savings because of their widespread use. At the same time, in particular, sustainability and the CO₂ balance of cement, gypsum, lime and other hydraulically setting compositions which are consumed in large volumes are to be improved.

It is a particular object of the invention to provide biobased polycarboxylate ethers. The biobased polycarboxylate ethers shall be obtainable in a very simple manner and in large volumes. They shall be biobased in a maximum proportion. They shall differ to a minimum degree or only slightly from conventional polycarboxylate ethers in terms of their properties. More particularly, the efficacy thereof shall not be reduced compared to analogous products made from fossil raw materials.

### SUMMARY OF THE INVENTION

The object underlying the invention is achieved by processes, polycarboxylate ethers, uses, hydraulically settable compositions and shaped bodies according to the claims.

The invention provides a process for preparing polycarboxylate ethers, in which at least one biobased starting material is used. Therefore, the polycarboxylate ether prepared is also biobased.

Polycarboxylate ethers are comb polymers having a main chain having carboxyl groups, and side chains having polyether groups, especially based on polyethylene oxide (polyethylene glycol; PEG) and/or polypropylene oxide. The side chains may have, as well as the ether groups, further functional groups, especially ester and amide groups. The particular role of ester groups, in addition to ether and amide groups, is to join the main chain to side chains. Polycarboxylate ethers having ester groups are therefore also referred to in the prior art as “polycarboxylate esters”.

The term “starting material” (reactant) means that the material is converted chemically to the polycarboxylate ether in the course of processing, i.e. is consumed.

The polycarboxylate ether may be entirely or partly biobased. This depends on the extent to which biobased starting materials are used in the production.

The term “biobased” means in accordance with the invention that a compound, a material or the like, for example a starting material or a polycarboxylate ether, has been produced at least partly from biological materials or from renewable agricultural materials or silvicultural materials. The materials are especially of plant or animal origin, algae or microorganisms. Biobased starting materials are based in accordance with the invention especially on renewable raw materials, particularly from agricultural or silvicultural production.

These biobased starting materials may be obtained directly from such materials or be produced from such materials by conversion reactions. The conversion reactions may be or include biochemical processes such as fermentation processes, or be or comprise other processes such as organic synthesis and reactions.

The polycarboxylate ethers of the invention are therefore based partly at most, and in a particularly preferred embodiment not at all, on fossil raw materials, especially not on mineral oil. Products based solely on fossil raw materials are, in accordance with the invention and in accordance with common terminology, not referred to as biobased. Fossil raw materials have formed in the geological past from dead life forms and include brown coal, hard coal, peat, natural gas and mineral oil.

In a preferred embodiment, at least one biobased starting material is selected from the group consisting of polyethylene oxide, terminally modified polyethylene oxide, acrylic acid or a salt thereof, methacrylic acid or a salt thereof and/or maleic acid or a salt thereof.

The term “acid” in the context of this application, in the case of organic acids, refers not just to the protonated acid but also to salts of the acid and partly neutralized mixtures thereof.

In a preferred embodiment, the biobased starting material used is polyethylene oxide. The polyethylene oxide may have been terminally modified at one end of the polyethylene oxide chain or at both ends. The term “end” means the two chain ends of the polymer. In a preferred embodiment, the polyethylene oxide has been terminally modified only at one end and has a free hydroxyl group at the other end.

In a preferred embodiment, the terminally modified polyethylene oxide has been modified with an alkenyl radical at one end. The alkenyl radical preferably has a single C—C double bond. The alkenyl radical preferably has 2 to 10, especially 2 to 6, carbon atoms. The alkenyl radical is preferably selected from allyl, vinyl, methallyl and isoprenyl. The other end of the chain may be unsubstituted and thus have a free OH group, or be substituted, especially by an alkyl group. Such unsaturated derivatives of polyalkylene oxide can be incorporated into polycarboxylate ethers by polymerization in a simple manner. The biobased modified polyalkylene oxide derivative is preferably a compound of the formula (Ia):

R¹—O-[AO]ₙ—R² (Ia)

where
R¹ is an alkenyl group,
R² is H, an alkyl group having 1 to 20 carbon atoms, or an aryl, cycloalkyl or alkylaryl group having 7 to 20 carbon atoms, especially methyl or ethyl,
A is independently a C₂- to C₆-alkylene group, especially ethylene or propylene, and
n=2 to 300, especially 3 to 200 or 5 to 150.
In a particularly preferred embodiment, R²═H. Such derivatives of polyalkylene oxides generally have particularly good availability. In particularly preferred embodiments, the monomer of the formula R¹—O-[AO]ₙ—H is isoprenyl polyethylene glycol, allyl polyethylene glycol, methallyl polyethylene glycol, isobutenyl polyethylene glycol or vinyl polyethylene glycol.

In further embodiments, in the monomer of the formula R¹—O-[AO]ₙ—R², the R² radical is different from H, and is especially a C₁ to C₆ alkyl group. In that case, the monomer may be, for example, (isoprenyl polyethylene glycol) methyl ether, (allyl polyethylene glycol) methyl ether, (vinyl polyethylene glycol) methyl ether, (isoprenyl polyethylene glycol) ethyl ether, (allyl polyethylene glycol) ethyl ether, (methallyl polyethylene glycol) ethyl ether or (vinyl polyethylene glycol) ethyl ether.

In a further preferred embodiment, the biobased terminally modified polyalkylene oxide has been modified terminally only at one end of the chain, the pendant radical being unreactive and especially having no C—C double bond. The radical is preferably an alkyl group, especially methyl or ethyl. Such derivatives of polyalkylene oxide can be incorporated into polycarboxylate ethers in a simple manner by polymer-analogous reactions, especially esterification or etherification. In this case, preference is given to using a biobased monomer of the formula (IIa)

HO-[AO]ₙ—R² (IIa)

where
R² is an alkyl group having 1 to 20 carbon atoms, or an aryl, cycloalkyl or alkylaryl group having 7 to 20 carbon atoms, especially methyl or ethyl,
A is independently a C₂- to C₆-alkylene group, especially ethylene or propylene, and
n=2 to 300, especially 3 to 200 or 5 to 150.

In a preferred embodiment of the invention, in the process of the invention, at least one biobased starting material which is a biobased organic compound having 2 or 3 carbon atoms, or which has been obtained from a biobased organic compound having 2 or 3 carbon atoms, is used. The biobased organic compound having 2 or 3 carbon atoms preferably consists exclusively of C, H and O and optionally has one or two double bonds.

Preferably, the biobased organic compound having 2 or 3 carbon atoms is purified before it is converted further to the polycarboxylate ethers or to biobased starting materials for production thereof. In the production of polymers from biobased raw materials, there is generally the problem that intermediates formed from renewable raw materials are often unobtainable in uniform quality. This is problematic or even hazardous in the case of incorporation into cements, lime or gypsum, when the products do not have the desired stability and develop faults such as cracks or bubbles over long periods. But when biobased low molecular weight compounds, especially organic compounds having 2 or 3 carbon atoms, are used as starting materials, these can be purified before further processing to give polycarboxylate ethers. Since low molecular weight biobased compounds are obtainable in high purity, it is possible to achieve a high and continuous quality of biobased products produced therefrom.

In preferred embodiments, the biobased organic compounds having 2 or 3 carbon atoms are ethanol, glycerol, ethylene, acrolein, 3-hydroxypropionic acid, 2-hydroxypropionic acid and/or salts thereof.

In a preferred embodiment, the polyethylene oxide has been obtained from biobased ethanol (“bioethanol”). More particularly, the polyethylene oxide has been obtained by a process having the steps of
(a) dehydrating biobased ethanol to ethylene,
(b) oxidizing the ethylene to ethylene oxide, and
(c) polymerizing the ethylene oxide to polyethylene oxide.

Bioethanol can be obtained by fermentation from biological raw materials, especially from sugars or sugar-containing materials. Sugars are generally biobased and can be isolated from various renewable raw materials. Particularly suitable raw materials are plants having a high sugar content, such as sugarcane or sugarbeet. It is first possible to separate an extract having a high sugar content from such plants, such as molasses. The sugar content can optionally be increased by further purification steps such as distillation. The extract can subsequently be fermented using suitable yeast, bacteria and/or enzymes to give methanol. Processes for producing bioethanol from sugars are known in the prior art.

The ethanol can be dehydrated to obtain ethylene. The ethylene can then be converted to ethylene oxide. This reaction is typically effected with oxygen in the presence of catalysts.

The biobased polyethylene oxide is then prepared by polymerization of ethylene oxide. In the course of this, or subsequently, the polyethylene oxide can be modified with a desired terminal group, for example an alkenyl group and/or an alkyl group.

Biobased polyethylene oxides optionally having terminal modification are commercially available from India Glycol, India, for example under the Igsurf-1200 AP (having a terminal vinyl group) or Polymeg 1000 M (having a terminal methyl group) brand names.

In a preferred embodiment, the acrylic acid or a salt thereof has been obtained from sugars. More particularly, the acrylic acid or a salt thereof has been obtained by a process having the steps of
(a) isolating or producing 3-hydroxypropionic acid, 2-hydroxypropionic acid and/or salts thereof from biological material, and
(b) dehydrating the 3-hydroxypropionic acid, 2-hydroxypropionic acid and/or salts thereof to acrylic acid or a salt thereof.

Starting material used in this process, in step (a), is preferably glycerol or a sugar, especially glucose, or a plant extract having a high sugar content. The sugar is subsequently converted to 2-hydroxypropionic acid (lactic acid) and/or 3-hydroxypropionic acid (3-HPA) and/or salts thereof, preferably by fermentation using suitable yeasts, bacteria and/or enzymes. The biobased acrylic acid or a salt thereof can subsequently be obtained by dehydrating the hydroxypropionic acid. Such a process is known in the prior art and is described in DE 10 2006 039 203 A1.

In a further preferred embodiment, the acrylic acid or a salt thereof has been obtained by a process having the steps of
(a) dehydrating biobased glycerol to acrolein, and
(b) oxidizing the acrolein to acrylic acid or a salt thereof.

Glycerol is obtained as a by-product in biodiesel production. This is usually effected by transesterification of usually vegetable oils with methanol. This involves reacting a triacylglyceride with methanol to give glycerol and fatty acid methyl esters. Also known is biotechnological production by fermentation with yeast. Dehydration can convert the glycerol to acrolein, followed by an oxidation to give biobased acrylic acid or a salt thereof. Such a process is known in the prior art and is described in WO2006/092272 or the corresponding US2009/0134357 A1.

Processes for producing biobased maleic acid have been described in the prior art. The Danish company Novozymes, for example, has developed a process for producing biobased maleic acid by means of microorganisms.

In a preferred embodiment of the invention, preparation of the polycarboxylate ethers is accomplished using biobased acrylic acid or a salt thereof and biobased polycarboxylate ethers. Biobased polycarboxylate ethers may have been terminally modified. Such a combination can achieve a relatively high biobased content.

Processes for preparing biobased methacrylic acid have been described in the prior art. Preference is given to using methacrylic acid or a salt thereof which has been prepared from 2-hydroxyisobutyric acid or tent-butanol. Both starting materials are obtainable in large volumes from biobased raw materials. Corresponding methods are described, for example, in Rohwerder and Müller, Microbial Cell Factories 2010, 9, 13, p. 1-10. In a preferred embodiment of the invention, the polycarboxylate ethers are produced by using biobased acrylic acid and/or biobased methacrylic acid or salts thereof and biobased polycarboxylate ethers.

The invention also provides an at least partly biobased polycarboxylate ether. This polycarboxylate ether is especially obtainable by the process of the invention.

The polycarboxylate ether of the invention has ¹⁴C atoms. By the determination of the ¹⁴C content, it is possible to establish unambiguously whether and in what proportion a polycarboxylate ether is biobased. Biobased polycarboxylate ethers differ from non-biobased polycarboxylate ethers by a measurable proportion of the ¹⁴C carbon isotope. The ¹⁴C isotope present in the atmosphere has a half-life of about 5730 years and is incorporated into living biological organisms. A fresh organic sample contains about 1 ppt (parts per billion, 10⁻¹²) of ¹⁴C atoms, based on the sum total of all carbon atoms. In dead organisms, the amount of bound radioactive ¹⁴C atoms decreases according to the decay law, but the decrease is only measurable over long periods. Organic compounds which have been produced from fossil raw materials are not “biobased” and do not have a measurable ¹⁴C content. The ¹⁴C content of a sample can be determined analytically. The content can be used to determine the proportion in which the polycarboxylate ether is biobased. Preferably, the ¹⁴C content and the biobased content of the polycarboxylate ether are determined in accordance with ASTM D6866 “Standard Test Methods for Determining the Biobased Content of Solid, Liquid, and Gaseous Samples Using Radiocarbon Analysis”.

The proportion of ¹⁴carbon atoms in the polycarboxylate ether is preferably more than 0.1 ppt, especially more than 0.25 ppt, more than 0.5 ppt or more than 0.8 ppt, based on the sum total of all the carbon atoms present.

In preferred embodiments, the polycarboxylate ether is biobased to an extent of at least 10%, especially to an extent of more than 25%, to an extent of more than 50%, to an extent of more than 75%, to an extent of more than 90%, to an extent of more than 95%, to an extent of more than 98% or to an extent of 100%.

The polycarboxylate ether has side chains attached to a main chain via ester, ether, amide and/or imide groups. Preference is given to ester, ether and/or amide groups, especially ester and/or ether groups. The main chain has at least one acid unit or a salt thereof. The acid unit is especially an α-unsaturated mono- or dicarboxylic acid such as acrylic acid, methacrylic acid, maleic anhydride, maleic acid, itaconic acid, crotonic acid or fumaric acid. The acid unit is preferably acrylic acid, methacrylic acid, maleic acid and/or a salt thereof and/or combinations thereof.

More particularly, the side chains contain polyalkylene oxide side chains, preferably polyethylene oxide units. Preferably, at least 50 mol %, especially at least 75 mol % and preferably at least 95 mol % or 100 mol % of the side chains include or consist of polyalkylene oxide.

Preferably, a proportion of ethylene oxide units in the polyalkylene oxide side chains, based on all the alkylene oxide units present in the side chains, is more than 90 mol %, especially more than 95 mol %, preferably more than 98 mol %, specifically 100 mol %.

Preferably, the polyalkylene oxide side chains do not have any hydrophobic groups, especially no alkylene oxides having three or more carbon atoms. A high proportion of ethylene oxide units or a small content of alkylene oxides having three or more carbon atoms reduces the risk of unwanted introduction of air.

The polyalkylene oxide side chains especially have a structure of formula -[AO]ₙ—R^{a}. In particular, A=C₂- to C₅-alkylene, which may be branched or unbranched. R^{a} is preferably H, a C₁- to C₂₀-alkyl group, -cyclohexyl group or -alkylaryl group. Advantageously, n=2 to 300, especially 3 to 200 or 5 to 150.

A weight-average molecular weight (M_{W}) of the polycarboxylate ether is especially 5′000-150′000 g/mol, preferably 10′000-100′000 g/mol. A number-average molecular weight (Mₙ) of the polycarboxylate ether is advantageously 3000-100′000 g/mol, especially 8′000-70′000 g/mol.

The polycarboxylate ether preferably comprises or consists of the following substructural units:
a) a molar parts of a substructural unit S1 of the formula (I)

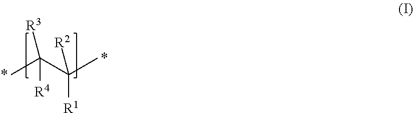

b) b molar parts of a substructural unit S2 of the formula (II)

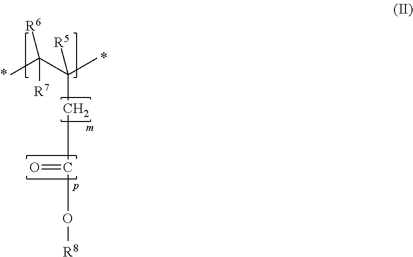

c) optionally c molar parts of a substructural unit S3 of the formula (III)

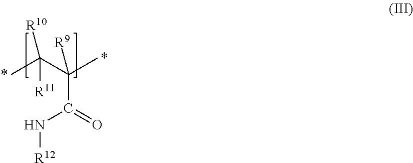

d) optionally d molar parts of a substructural unit S4 of the formula (IV)

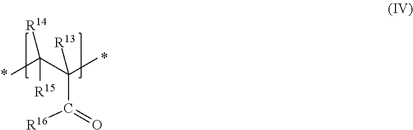

where
R¹, independently at each instance, is —COOM, —SO₂-OM, —O—PO(OM)₂ and/or —PO(OM)₂,
R², R³, R⁵, R⁶, R⁹, R¹⁰, R¹³ and R¹⁴, each independently of one another, are H or an alkyl group having 1 to 5 carbon atoms,
R⁴, R⁷, R¹¹ and R¹⁵, each independently of one another, are H, —COOM or an alkyl group having 1 to 5 carbon atoms,
M, independently at each instance, is H⁺, an alkali metal ion, an alkaline earth metal ion, a di- or trivalent metal ion, an ammonium ion, an organic ammonium group,
m=0, 1 or 2,
p=0 or 1,
R⁸ and R¹², each independently of one another, are a C₁- to C₂₀-alkyl group, -cycloalkyl group, -alkylaryl group or a group of the formula -[AO]ₙ—R^{a},
   where A=C₂- to C₄-alkylene, R^{e} is H, a C₁- to C₂₀-alkyl group, -cyclohexyl group or -alkylaryl group,
   and n=2 to 300, especially 3 to 200 or 5 to 150,
R¹⁶, independently at each instance, is NH₂, —NR^{b}R^{c}, —OR^{d}NR^{e}R^{f},
   where R^{b} and R^{c}, independently of one another, are
      a C₁- to C₂₀-alkyl group, -cycloalkyl group, -alkylaryl group or -aryl group,
      or a hydroxyalkyl group or acetoxyethyl (CH₃—CO—O—CH₂—CH₂—) or hydroxyisopropyl (HO—CH(CH₃)—CH₂—) or acetoxyisopropyl group (CH₃—CO—O—CH(CH₃)—CH₂—);
   or R^{b} and R^{c} together form a ring of which the nitrogen is part, in order to create a morpholine or imidazoline ring;
   R^{d} is a C₂-C₄-alkylene group,
   R^{e} and R^{f} are each independently a C₁- to C₂₀-alkyl group, -cycloalkyl group, -alkylaryl group, -aryl group or hydroxyalkyl group,
      and where a, b, c and d are mole fractions of the respective substructural units S1, S2, S3 and S4, with a/b/c/d=(0.05-0.95)/(0.05-0.8)/(0-0.3)/(0-0.3), especially a/b/c/d=(0.3-0.9)/(0.1-0.6)/(0-0.15)/(0-0.15), preferably a/b/c/d=(0.5-0.8)/(0.2-0.5)/(0-0.1)/0 and with the proviso that a+b+c+d=1.

The sequence of substructural units S1, S2, S3 and S4 may be alternating, in blocks or random. It is further also possible that further substructural units are present in addition to the substructural units S1, S2, S3 and S4.

Preferably, the substructural units S1, S2, S3 and S4 together have a proportion by weight of at least 50% by weight, especially at least 90% by weight, most preferably at least 95% by weight, of the total weight of the polycarboxylate ether.

A ratio of a/(b+c+d) is especially in the range of 1-5.

More particularly, in the polycarboxylate ether, R¹=COOM, R²=H or CH₃, R³=R⁴=H. Thus, the polycarboxylate ether can be prepared on the basis of acrylic or methacrylic acid monomers, which is of interest from an economic point of view. In addition, a good reduction in viscosity arises with such polycarboxylate ethers in the present context.

Likewise advantageous are polycarboxylate ethers with R¹=COOM, R²=H, R³=H and R⁴=COOM. Such polycarboxylate ethers can be prepared on the basis of maleic acid monomers.

Advantageously, R⁵=H or CH₃ and R⁶=R⁷=H. Such polycarboxylate ethers can be prepared, for example, proceeding from (meth)acrylic esters, or vinyl (meth)allyl or isoprenol ethers.

If S3 is present, it is especially the case that R⁹=H or CH₃ and R¹⁰=R¹¹=H.

If S4 is present, it is especially the case that R¹³=H or CH₃ and R¹⁴=R¹⁵=H.

Very particularly advantageously, R² and R⁵ are mixtures of H and —CH₃. Preference is given to mixtures having 40-60 mol % of H and 40-60 mol % of —CH₃. If the corresponding substructural units are present, this especially also applies to R⁹ and R¹³. In this case, it is additionally preferable that R³ and R⁶ are H, and, if the corresponding substructural units are present, R⁹ and R¹³ are H.

In further advantageous embodiments, R¹=COOM, R²=H, R⁵=—CH₃ and R³=R⁴=R⁶==H.

In another advantageous embodiment, R¹=COOM, R²=R⁵=H or —CH₃ and R³=R⁴=R⁶=R⁷=H.

More particularly, R⁸ and/or R¹² is -[AO]ₙ—R^{a} where, preferably, A=C₂-alkylene and/or R^{a} is H or a C₁-alkyl group. Advantageously, n=2-300, especially n=3-200, preferably n=5-150.

In particular, m=0 and p=1. Likewise advantageously, m=1 or 2 and p=0, where, in particular, R⁵ is —CH₃.

In the case of particularly preferred polycarboxylate ethers:
a) R¹ is COOM;
b) R² and R⁵, independently of one another, are H, —CH₃ or mixtures thereof. Very particularly advantageously, R² and R⁵ are mixtures of H and —CH₃. Preference is given to mixtures having 40-60 mol % of H and 40-60 mol % of —CH₃. In the presence of substructural units S3 and/or S4, this is especially also true of R⁹ and R¹³;
c) R³ and R⁶ are H. In the presence of substructural units S3 and/or S4, this is especially also true of R¹⁰ and/or R¹⁴;
d) R⁴ and R⁷, independently of one another, are H or —COOM, preferably H. In the presence of substructural units S3 and/or S4, this is especially also true of R¹¹ and R¹⁵;
e) R⁸ is -[AO]ₙ—R^{a} where, preferably, A=C₂-alkylene and/or R^{a} is H or a C₁-alkyl group. Advantageously, n=2-300, especially n=3-200, preferably n=5-150. In the presence of substructural units S3, this is especially also true of R¹².
f) m=0 and p=1.

The polycarboxylate ethers of the invention can be prepared in a manner known per se. This is especially done using the polymer-analogous reaction or free-radical polymerization.

The polycarboxylate ethers can be prepared by the polymer-analogous reaction. This is done by first preparing a main chain which is then equipped with side chains. Polymer-analogous reactions are known per se and are described, for example, in WO97/35814A1, WO95/09821A2, DE 100 15 135A1, EP 1138697A1, EP1348729A1 and WO2005/090416A1. Details of polymer-analogous reaction are disclosed, for example, in EP 1 138 697 B1 at page 7 line 20 to page 8 line 50, and in the examples present therein, or in EP 1 061 089 B1 auf page 4 line 54 to page 5 line 38 and in the examples.

The polymer-analogous process especially comprises the steps of:
a) providing and/or preparing a base polymer BP comprising or consisting of a structural unit of the formula V

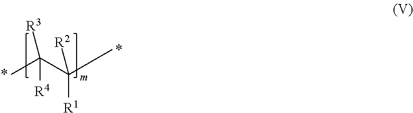

where
M, R¹, R², R³ and R⁴ are as defined above, where R¹ is especially—COOM, and
m>2, especially m=20-100;
b) esterifying the base polymer BP with a compound of the formula VI

HO—R⁸ (VI)
c) optionally amidating the base polymer BP with a compound of the formula VII

H₂N—R¹² (VII)
d) optionally amidating and/or esterifying the base polymer BP with a compound of the formula VIII

H—R¹⁶ (VIII)
to give the polycarboxylate ether KP,
   where R⁸, R¹² and R¹⁶ are as defined above.

The base polymer BP in step a) is especially a polyacrylic acid, a polymethacrylic acid and/or a copolymer of acrylic acid and methacrylic acid. A number-average molecular weight (Mₙ) of the base polymer BP of the formula (V) is, in particular, 500-20′000 g/mol, especially 500-10′000 g/mol, further preferably 3′000-6′000 g/mol.

Base polymers BP of this kind can be prepared in a manner known per se from acrylic acid monomers and/or methacrylic acid monomers. However, it is also possible, for example, to use maleic acid monomers and/or maleic anhydride monomers. This may be advantageous from an economic and safety point of view among other aspects.

The base polymer BP is prepared in step a) especially by aqueous free-radical polymerization, for example of acrylic acid and/or methacrylic acid, in the presence of a free-radical initiator and/or molecular weight regulator.

The free-radical initiator in step a) especially comprises sodium peroxodisulfate, potassium peroxodisulfate or ammonium peroxodisulfate. Likewise suitable as a free radical initiator in step a) is, for example, a redox pair based on H₂O₂/Fe²⁺.

Preferably, the molecular weight regulator in step a) is an alkali metal sulfite or hydrogen sulfite. Likewise advantageous is a phosphinic acid derivative. The molecular weight regulator in step a) may also be an organic compound containing a thiol group.

Corresponding base polymers BP may in principle also be sourced commercially from various suppliers.

For the esterification in step b), it is possible to add acids and/or bases among other substances, for example as catalysts. Advantageously, the esterification is effected at elevated temperatures of 120-200° C., especially 160-180° C. This can significantly improve the yield.

The compounds of the formulae V, VI and VII used in step b) are commercially available from various suppliers.

The polycarboxylate ethers can also be prepared by a free-radical polymerization reaction in which the copolymer is obtained from corresponding ethylenically unsaturated acid, ester and amide monomers in the presence of a free-radical former. This process, also called “copolymerization process” hereinafter especially comprises a copolymerization of:
a molar parts of monomers M1 of the formula IX

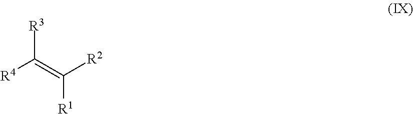

b molar parts of monomers M2 of the formula X

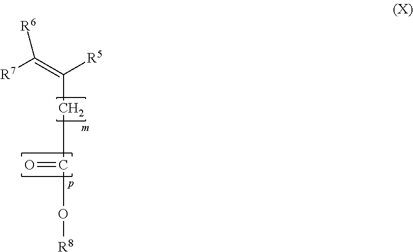

optionally c molar parts of monomers M3 of the formula XI

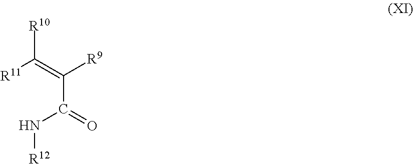

optionally d molar parts of monomers M4 of the formula XII

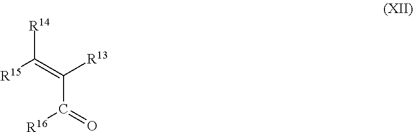

where a, b, c and d are the molar parts of the particular monomers M1, M2, M3 and M4,
where a, b, c, d, M, R¹-R¹⁶, m and p are as defined above,
where R⁸ is preferably H.

The monomers M2, M3 and M4 can be prepared in a manner known per se by esterification or amidation of acrylic acid, methacrylic acid, maleic acid and/or maleic anhydride with compounds of formulae VI, VII or VIII (see above).

For the copolymerization or the second process, it is possible to use the free-radical initiators and/or molecular weight regulators already mentioned above in connection with the first process.

The invention also provides a hydraulically settable composition comprising a polycarboxylate ether of the invention and a hydraulically settable binder. The term “hydraulically settable composition” is understood to mean compositions comprising hydraulically settable binders. Binders of this kind are inorganic materials which cure in the presence of water. Suitable binders and compositions are known to the person skilled in the art in the field of construction chemistry. In a preferred embodiment of the invention, the hydraulically settable binder in the composition is or comprises cement, gypsum or lime. Standard cements are, for example, portland cements or high-alumina cements and the respective mixtures thereof with standard additions.

The polycarboxylate ether of the invention is preferably used in an amount of 0.01% to 5% by weight, especially 0.05% to 2% by weight or 0.1% to 1% by weight, based on the weight of the hydraulically settable binder. The polycarboxylate ether is preferably used in the form of a liquid composition, especially as an aqueous solution.

The polycarboxylate ether of the invention is preferably used as a dispersant and especially as a superplasticizer, as a water reducer, for improving processibility and/or for improving free flow of the hydraulically settable compositions produced therewith, and for improving the stability of the cured products. More particularly, it is possible in accordance with the invention to obtain hydraulically settable compositions having prolonged processibility. This means that the composition is still processible over a prolonged period after addition of water and the polycarboxylate ether, compared to compositions that do not contain the polycarboxylate ether.

According to the invention, the polycarboxylate ether increases the free flow of a hydraulically settable composition. Preferably, the addition of the polycarboxylate ether increases the slump flow by at least 5%, especially more than 10%, even more preferably by more than 15% or more than 25%, in each case compared to an identical composition without polycarboxylate ether. The slump flow is ascertained, for example, with a free-flowing sample having 0.2% by weight of polycarboxylate ether (based on the amount of the hydraulically setting binder), especially after mixing with water and stirring vigorously for 30 seconds, in a 50 mm mini-cone, fill height 51 mm, after 75 seconds. The slump flow can be ascertained as described in the working examples. It is also possible to use standard conditions according to DIN EN 132790-2 or DIN EN 12350-5—Testing fresh concrete—Part 5: Flow table test.

The polycarboxylate ether of the invention can be used as a dispersant or as a constituent of a dispersant in conjunction with further components. Further constituents may be other superplasticizers, for example polycarboxylate ethers (PCE), lignosulfonates, sulfonated naphthalene-formaldehyde condensates or sulfonated melamine-formaldehyde condensates; or accelerators, retardants, shrinkage reducers, defoamers, air pore formers or foam formers. Typically, the proportion of the polycarboxylate ether is 5% 100% by weight, especially 20% to 100% by weight, based on the total weight of the dispersant.

The polycarboxylate ether of the invention can also be used in the solid state of matter, for example in the form of flakes, powders, chips, pellets, granules or slabs. Such solid additions have good transportability and storability. The polycarboxylate ether, in the solid state of matter, may be a constituent of what is called a dry mix, for example of a cement composition, which is storable over a prolonged period and is typically packed in sacks or stored in silos and used. Such a dry mix is usable even after a prolonged storage period and has good free flow.

The polycarboxylate ether of the invention may be added to a hydraulically settable composition together with or shortly before or shortly after the addition of the water. A particularly suitable addition in this context has been found to be that in the form of an aqueous solution or dispersion, especially as make-up water or as part of the make-up water. The aqueous solution is especially prepared by subsequent mixing with water. The polycarboxylate ether of the invention may be added to a hydraulically settable composition, however, before or during the grinding operation thereof as well, for example to the process of grinding cement clinker to give cement.

The invention also provides shaped bodies obtainable by setting and curing a hydraulically settable composition of the invention. According to the invention, the term “shaped body” means any three-dimensional solid body that has been shaped, such as movable construction elements, buildings and parts of buildings, floors and coatings.

The invention also provides for the use of a polycarboxylate ether of the invention as a dispersant, especially as a superplasticizer, for hydraulically settable compositions.

The processes, polycarboxylate ethers and uses of the invention solve the problem underlying the invention. The invention provides biobased polycarboxylate ethers and simple and efficient processes for preparation thereof. According to whether just some or all the starting materials are biobased, it is possible to establish a desired biobased content. When biobased acid units and biobased polyalkylene oxide side chains are used, it is possible to achieve a biobased content of up to 100%. According to the invention, biobased polycarboxylate ethers having an advantageous CO₂ balance are provided. They enable considerable CO₂ savings in the construction sector. They can be used in an environmentally friendly manner for sustainable applications and reduce the costs for CO₂ certificates. The ¹⁴C content enables proof of the biobased origin and the content.

The process of the invention also enables production of polycarboxylate ethers from biobased raw materials, these having a high and uniform quality. The high and continuous quality can be achieved in accordance with the invention because, in the synthesis routes that can be taken, biobased intermediates having low molecular weights are used. The processing of low molecular weight intermediates, such as ethanol, glycerol, acrolein or 2- or 3-hydroxypropionic acid, can prevent variations in quality of the end product. The biobased polycarboxylate ethers are therefore also usable for applications where no variations in quality must occur, as in the case of dispersants for cement compositions.

### WORKING EXAMPLES

### Example 1

### Preparation of Polycarboxylate Ethers by Polymer-Analogous Esterification

A 1500 mL reaction vessel equipped with a mechanical stirrer system, temperature monitoring system, heating mantle and vacuum pump was initially charged with 160 g (corresponding to about 1 mol of COOH) of an aqueous polyacrylic acid (Sokalan PA25 CL PN; BASF, DE) having an average molecular weight of 4000-6000. To this were added 7.5 g of 50% sulfuric acid and 360 g of methyl polyethylene glycol (Polymeg 1000 M; India Glycol, India). The reaction mixture was heated to 175° C., in the course of which the water was distilled off. After stirring at this temperature for 30 minutes, 10 g of 50% sodium hydroxide solution were added cautiously to the reaction mixture. As soon as the reaction mixture had reached 175° C. again, the reaction was conducted up to the desired conversion at a reduced pressure of 80 mbar, which took about 1.5 hours. By means of UPLC, the MPEG content and the polymer content were then measured. It was thus possible to measure a polymer content of about 95% and a remaining MPEG content of about 5%. The melt was then cooled and diluted with water to a solids content of 40%-50%.

### Example 2

### Preparation of Polycarboxylate Ethers by Free Radical Polymerization with a Mixture of the Starting Materials

A stirred reaction vessel was initially charged with 165 g of water, 40 g of maleic anhydride (0.4 mol), 360 g of allyl polyethylene glycol (Igsurf-1200 AP, India Glycol, India) having an average molecular weight of 1200 g/mol (0.3 mol), 14.4 g of acrylic acid (0.2 mol), 1 g of a 10% aqueous solution of Fe(II)SO₄7H₂O and 2 g of sodium hypophosphite chain transfer agent. Thereafter, at a temperature of 20° C. to 35° C. and a pH of 2 to 4, over a period of 180 min, while stirring, 50 g of an 8.5% hydrogen peroxide solution and 50 g of a 10% aqueous Rongalit solution were added dropwise. After the dropwise edition had ended, a clear viscous polymer solution was obtained.

### Example 3

### Preparation of Polycarboxylate Ethers by Free-Radical Polymerization with Continuous Supply of Acrylic Acid

A stirred reaction vessel was initially charged with 200 g of water, 5 g of maleic anhydride (0.05 mol), 132 g of allyl polyethylene glycol (Igsurf-1200 AP, India Glycol, India) having an average molecular weight of 1200 g/mol (0.11 mol), 2.5 g of sodium hypophosphite and 1 g of a 10% aqueous solution of Fe(II)SO₄7H₂O. Thereafter, at a temperature of 20° C. to 35° C. and a pH of 2 to 3, over the course of 150 min, while stirring, a solution of 23 g of hydroxyethyl acrylate (0.2 mol), 16 g of acrylic acid (0.22 mol) and 50 g of water and, at the same time, over a period of 180 min, while stirring, 50 g of an 8.5% hydrogen peroxide solution and 50 g of a 10% aqueous Rongalit solution were added dropwise. After the dropwise addition had ended, a clear viscous polymer solution was obtained. The polymers obtained had an average molecular weight Mₙ of 30′000-40′000 g/mol.

1. A process for preparing polycarboxylate ethers, wherein at least one biobased starting material is used.

2. The process as claimed in claim 1, wherein the biobased starting material is selected from the group consisting of polyethylene oxide, terminally modified polyethylene oxide, acrylic acid or a salt thereof, methacrylic acid or a salt thereof and/or maleic acid or a salt thereof.

3. The process as claimed in claim 2, wherein the terminally modified polyethylene oxide has been modified at one end by an alkenyl radical which is selected from allyl, vinyl, methallyl and isoprenyl.

4. The process as claimed in claim 1, wherein the biobased starting material is a biobased organic compound having 2 or 3 carbon atoms, or wherein the biobased starting material has been obtained from a biobased organic compound having 2 or 3 carbon atoms.

5. The process as claimed in claim 2, in which the polyethylene oxide has been obtained by a process having the steps of
(a) dehydrating biobased ethanol to ethylene,
(b) oxidizing the ethylene to ethylene oxide, and
(c) polymerizing the ethylene oxide to polyethylene oxide.

6. The process as claimed in claim 2, in which the acrylic acid or a salt thereof has been obtained by a process having the steps of
(a) isolating or producing 2-hydroxypropionic acid, 3-hydroxypropionic acid and/or a salt thereof from biological material, and
(b) dehydrating the 2-hydroxypropionic acid, 3-hydroxypropionic acid and/or a salt thereof to give acrylic acid or a salt thereof;
or in which the acrylic acid or a salt thereof has been obtained by a process having the steps of
(a) dehydrating biobased glycerol to acrolein, and
(b) oxidizing the acrolein to acrylic acid or a salt thereof.

7. A polycarboxylate ether which is at least partly biobased, wherein the polycarboxylate ether is obtainable by a process as claimed in claim 1.

8. The polycarboxylate ether as claimed in claim 7, which is biobased to an extent of at least 50%.

9. The polycarboxylate ether as claimed in claim 7, which has ¹⁴C atoms, wherein the proportion of the ¹⁴C atoms is more than 0.1 ppt based on the sum total of all the carbon atoms present.

10. The polycarboxylate ether as claimed in claim 7, which has side chains bonded to a main chain via ester, amide and/or ether groups, wherein the main chain includes at least one acrylic acid unit or a salt thereof and/or at least one methacrylic acid unit or a salt thereof, and wherein at least some of the side chains include a polyalkylene oxide.

11. The polycarboxylate ether as claimed in claim 7, comprising or consisting of the following substructural units:
a) a molar parts of a substructural unit S1 of the formula (I) 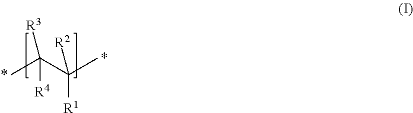
b) b molar parts of a substructural unit S2 of the formula (II) 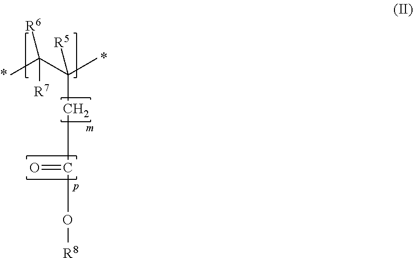
c) optionally c molar parts of a substructural unit S3 of the formula (III) 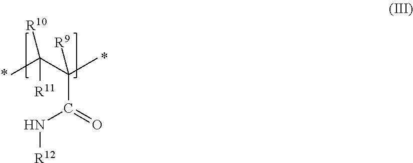
d) optionally d molar parts of a substructural unit S4 of the formula (IV) 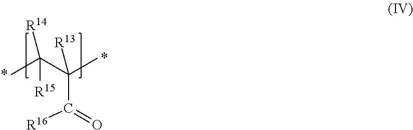
where
R¹, independently at each instance, is —COOM, —SO₂-OM, —O—PO(OM)₂ and/or —PO(OM)₂,
R², R³, R⁵, R⁶, R⁹, R¹⁰, R¹³ and R¹⁴, each independently of one another, are H or an alkyl group having 1 to 5 carbon atoms,
R⁴, R⁷, R¹¹ and R¹⁵, each independently of one another, are H, —COOM or an alkyl group having 1 to 5 carbon atoms,
M, independently at each instance, is H⁺, an alkali metal ion, an alkaline earth metal ion, a di- or trivalent metal ion, an ammonium ion, an organic ammonium group,
m=0, 1 or 2,
p=0 or 1,
R⁸ and R¹², each independently of one another, are a C₁- to C₂₀-alkyl group, -cycloalkyl group, -alkylaryl group or a group of the formula
-[AO]ₙ—R^{a},
where A=C₂- to C₄-alkylene, R^{a} is H, a C₁- to C₂₀-alkyl group, -cyclohexyl group or -alkylaryl group,
and n=2-300,
R¹⁶, independently at each instance, is NH₂, —NR^{b}R^{c}, —OR^{d}NR^{e}R^{f},
where R^{b} and R^{c}, independently of one another, are
a C₁- to C₂₀-alkyl group, -cycloalkyl group, -alkylaryl group or -aryl group,
or a hydroxyalkyl group or acetoxyethyl (CH₃—CO—O—CH₂—CH₂—) or hydroxyisopropyl (HO—CH(CH₃)—CH₂—) or acetoxyisopropyl group (CH₃—CO—O—CH(CH₃)—CH₂—);
or R^{b} and R^{c} together form a ring of which the nitrogen is part, in order to create a morpholine or imidazoline ring;
R^{d} is a C₂-C₄-alkylene group,
R^{e} and R^{f} are each independently a C₁- to C₂₀-alkyl group, -cycloalkyl group, -alkylaryl group, -aryl group or hydroxyalkyl group,
and where a, b, c and d are mole fractions of the respective substructural units S1, S2, S3 and S4, with a/b/c/d=(0.05-0.95)/(0.05-0.8)/(0-0.3)/(0-0.3), and with the proviso that a+b+c+d=1.

12. The polycarboxylate ether as claimed in claim 11, wherein R¹=COOM; R² and R⁵, independently of one another, are H, —CH₃ or mixtures thereof; R³ and R⁶, independently of one another, are H or —CH₃; R⁴ and R⁷, independently of one another, are H or —COOM; R⁸ is -[AO]ₙ—R^{a}, A=ethylene and R^{a} is H or methyl, and wherein n=3-250.

13. A hydraulically settable composition comprising a polycarboxylate ether as claimed in claim 7 and a hydraulically settable binder.

14. A shaped body obtainable by setting and curing a hydraulically settable composition of the invention as claimed in claim 13.

15. A method comprising hydraulically setting compositions by utilizing polycarboxylate ethers as claimed in claim 7 as dispersants.
